(19) United States
(12) Patent Application Publication
(10) Pub. No.: US 2004/0173753 A1
(43) Pub. Date: Sep. 9, 2004

(54) Semiconductor device for detecting neutron

(75) Inventor: Takashi Inbe, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., TOKYO (JP)

(21) Appl. No.: 10/623,562

(22) Filed: Jul. 22, 2003

(30) Foreign Application Priority Data
Mar. 7, 2003 (JP) 2003-061141

(51) Int. Cl. G01T 3/00

(52) U.S. Cl. 250/370.05; 250/390.01

(57) ABSTRACT

A silicon substrate (1) includes a neutron detecting part comprising a ¹⁰B diffusion layer which includes boron introduced therein containing isotopes ¹⁰B, an α-ray detecting part including a pn junction (13) defined by a p well (11) and an n well (12), and an analytic circuit part for analyzing electric charge generated in the pn junction (13), all of which are provided on a single chip. An α-ray generated in the ¹⁰B diffusion layer (10) as a result of entering of neutrons generates electron-hole pairs (16) in a depletion layer of the pn junction (13). The analytic circuit part collects and analyzes electric charge of the electron-hole pairs (16). On the basis of the result of analysis, the volume of neutrons entering into the pn junction (13) is specified.

### BACKGROUND OF THE INVENTION

1. Field of the Invention

The present invention relates to a semiconductor device for detecting radiation, and more particularly, it relates to a semiconductor device for detecting neutron.

2. Description of the Background Art

For detecting a neutron ray in radiation detection, a detector using a BF₃ counter tube or a detector utilizing activation of a metal thin film has conventionally been employed. The counter tubes used in these types of neutron detectors have difficulty in downsizing, thereby causing upsizing of the detectors as a whole. Moreover, these neutron detectors cannot respond to real-time measurement of a neutron radiation field.

A semiconductor radiation detector is also known, an example of which is introduced in Japanese Patent Application Laid-Open No. 2000-147129 (pp. 5-6 and FIG. 4). The semiconductor detector provides high resolution, and in contrast to the counter tube, is significantly small in size. When measurement of a radiation field places emphasis on a direction of travel of radiation particles, for example, such semiconductor detector can effectively be used accordingly for providing precise monitoring of the radiation field.

The semiconductor detector conventionally used is made of a plurality of semiconductor devices, thereby causing a considerable increase in cost or disturbance in measurement of a neutron radiation field.

### SUMMARY OF THE INVENTION

In a semiconductor device for detecting neutrons, it is an object of the present invention to realize high-precision measurement of a neutron radiation field, while allowing cost reduction of the device.

According to the present invention, the semiconductor device includes a ¹⁰B diffusion layer, a pn junction, and an analytic circuit. The ¹⁰B diffusion layer contains an isotope ¹⁰B of boron introduced therein. The pn junction detects an α-ray generated in the ¹⁰B diffusion layer. The analytic circuit analyzes electric charge generated in the pn junction. The ¹⁰B diffusion layer, the pn junction, and the analytic circuit are provided on a single semiconductor chip.

The semiconductor device for detecting neutrons can be significantly small in size. A region where an α-ray is generated as a result of entering of neutrons (¹⁰B diffusion layer), and a part for detecting this α-ray (pn junction), are in close proximity to each other. This provides improvement in detection efficiency and detection accuracy of an α-ray, resulting in suppression of disturbance in measurement of a neutron radiation field, and eventually, in high-precision measurement of a neutron radiation field. Further, cutback in the number of required chips contributes to cost reduction.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a configuration of a neutron detecting device according to a first preferred embodiment of the present invention;

FIG. 2 illustrates a configuration of a neutron detecting device according to a second preferred embodiment of the present invention; and

FIG. 3 shows an exemplary layout of a neutron detecting device according to a third preferred embodiment of the present invention.

### DESCRIPTION OF THE PREFERRED EMBODIMENTS

First Preferred Embodiment

A neutron has no electric charge, and therefore, it cannot be directly detected by a semiconductor element. In view of this, a neutron should be once reacted with other substance, whereby it is indirectly detected. As a known way thereof, a neutron is reacted with an isotope ¹⁰B of boron, and an α-ray thereby generated is detected.

FIG. 1 illustrates a configuration of a neutron detecting device as a semiconductor device according to the first preferred embodiment of the present invention. Elements provided in a silicon substrate (semiconductor chip) 1 are isolated from each other by element isolation films 2. The silicon substrate 1 includes a neutron detecting part comprising a ¹⁰B diffusion layer 10 which includes boron introduced therein containing isotopes ¹⁰B (in a natural state, boron contains about 20% of isotopes ¹⁰B), an α-ray detecting part including a pn junction 13 defined by a p well 11 and an n well 12, and an analytic circuit part which may comprise an MOS transistor including a gate electrode 14, and source/drain regions 15, all of which are provided on a single chip.

The ¹⁰B diffusion layer 10 in the neutron detecting part is formed by ion implantation of boron containing isotopes ¹⁰B into the silicon substrate 1. The p well 11 and the n well 12 are also formed by introducing certain dopants in the silicon substrate 1. That is, the neutron detecting part and the α-ray detecting part are formed by the ordinary semiconductor processing technique.

The configuration of the analytic circuit part varies depending on an object of analysis. By way of example, the analytic circuit part may be a suitable combination of fundamental circuits including an amplifying circuit for amplifying a very low-level signal, a single-channel pulse height analyzing circuit for selecting only a pulse of specific height, a coincidence circuit for checking on temporal coincidence between two different pulses, a scaling circuit for counting the number of pulses, and a multichannel pulse height analyzing circuit for automatically analyzing a frequency distribution of pulse height.

The operation of the neutron detecting device according to the first preferred embodiment will be discussed. First, neutrons entering into the ¹⁰B diffusion layer 10 react with isotopes ¹⁰B, thereby causing ¹⁰B (n, a)⁷ Li reaction to emit an α-ray. The α-ray emitted from the neutron detecting part plunges into the α-ray detecting part near the neutron detecting part, to generate electron-hole pairs 16 in a depletion layer of the pn junction 13. The analytic circuit part collects electric charge of the electron-hole pairs 16 to detect a current flowing in the pn junction 13, whereby the α-ray is detected. The analytic circuit part also amplifies a very low-level signal generated by pulsation of the amount of the collected electric charge of electron-hole pairs 16 (current pulsation in the pn junction 13). The signal thereby amplified then undergoes analysis. For example, the number of pulses is counted, or an energy spectrum of the α-ray is determined according to a pulse height distribution. On the basis of the result of analysis, the volume of neutrons entering into the neutron detecting part is specified.

As described, electric charge of the electron-hole pairs 16 is immediately analyzed by the analytic circuit part, whereby instant (real-time) monitoring of the volume of radiated neutrons is realized. Further, as the neutron detecting part, the α-ray detecting part, and the analytic circuit part are provided on a one-chip semiconductor device, the overall configuration of a neutron detector can be significantly small in size. Still further, a region where an α-ray is generated as a result of entering of neutrons (¹⁰B diffusion layer 10), and a part for detecting this α-ray (pn junction 13), are in close proximity to each other. This provides improvement in detection efficiency and detection accuracy of an α-ray, resulting in suppression of disturbance in measurement of a neutron radiation field, and eventually, in high-precision measurement of the neutron radiation field. Yet further, cutback in the number of required chips contributes to cost reduction.

Second Preferred Embodiment

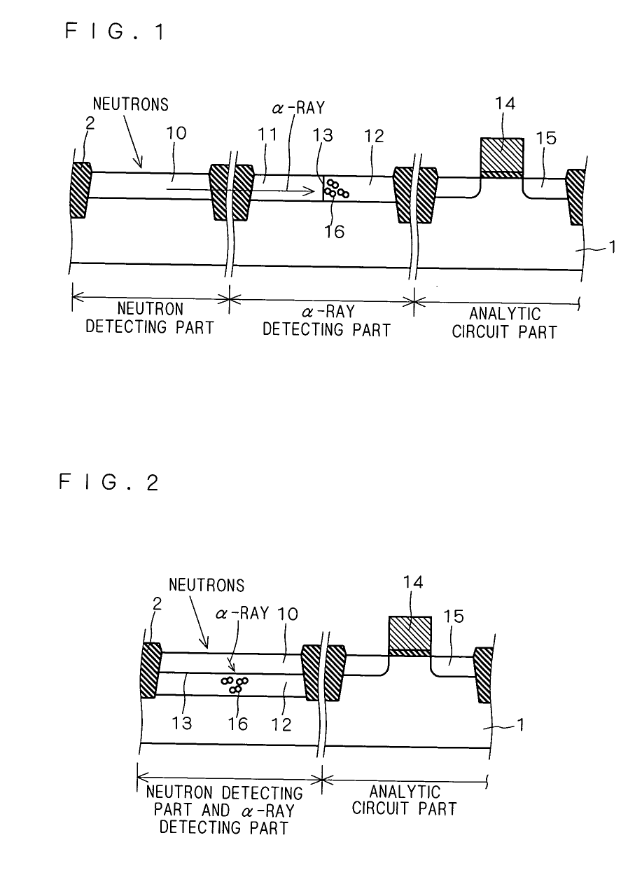

FIG. 2 illustrates a configuration of a neutron detecting device as a semiconductor device according to the second preferred embodiment of the present invention. In FIG. 2, the same elements as those in FIG. 1 are designated by the same reference numerals, and the detailed description thereof is omitted here. As shown in FIG. 2, the ¹⁰B diffusion layer 10 and the p well 12 including certain n-type dopants introduced therein (such as P(phosphorous) or As (arsenic)) are provided in the same element region. The ¹⁰B diffusion layer 10 is provided in a periphery of an upper surface of the silicon substrate 1. The n well 12 is provided in the same element region of the ¹⁰B diffusion layer 10, reaching a depth in the silicon substrate 1 greater than that of the ¹⁰B diffusion layer 10. The ¹⁰B diffusion layer 10 is of p-type, and therefore, the pn junction 13 is defined between the ¹⁰B diffusion layer 10 and the n well 12. That is, in the second preferred embodiment, the neutron detecting part including the ¹⁰B diffusion layer 10, and the α-ray detecting part including the pn junction 13, are formed in the same element region.

The operation of the neutron detecting device according to the second preferred embodiment will be discussed. First, neutrons entering into the ¹⁰B diffusion layer 10 (neuron detecting part) react with isotopes ¹⁰B, thereby causing ¹⁰B (n, a)⁷ Li reaction to emit an α-ray. The α-ray emitted from the ¹⁰B diffusion layer 10 generates the electron-hole pairs 16 in a depletion layer of the pn junction 13 (α-ray detecting part) which is defined under the ¹⁰B diffusion layer 10. The analytic circuit part collects electric charge of the electron-hole pairs 16 to detect a current flowing in the pn junction 13, whereby the α-ray is detected. Similar to the first preferred embodiment, the analytic circuit part also performs analysis based on pulsation of the amount of collected electric charge of the electron-hole pairs 16 (current pulsation in the pn junction 13). On the basis of the result of analysis, the volume of neutrons entering into the neutron detecting part is specified.

As described, electric charge of the electron-hole pairs 16 is immediately analyzed by the analytic circuit part, whereby instant (real-time) monitoring of the volume of radiated neutrons is realized. Further, the 10B diffusion layer 10 as a neutron detecting part is also operative to serve as a p-type diffusion layer for defining the pn junction 13. Therefore, a region where an α-ray is generated (¹⁰B diffusion layer 10), and the part for detecting this α-ray (pn junction 13), are spaced with the minimum possible distance therebetween. This provides improvement in detection efficiency and detection accuracy of an α-ray, resulting in high-precision measurement of a neutron radiation field. Still further, the neutron detecting part and the α-ray detecting part are provided in the same element region. As compared with the first preferred embodiment, it is thus allowed to shrink the overall configuration of a neutron detector to a greater degree.

Third Preferred Embodiment

As understood from the foregoing description of the first and second preferred embodiments, the neutron detecting device according to the present invention comprises a neutron detecting part, an α-ray detecting part and an analytic circuit part, all of which are provided on a single chip. Such configuration brings the neutron detecting part and the α-ray detecting part to be in close proximity to each other, thereby realizing high-precision measurement of a neutron radiation field. On the other hand, it is quite likely that an α-ray generated in the neutron detecting part will enter into the analytic circuit part. Such probability may cause a malfunction (soft error) of the analytic circuit part, resulting in reduction in reliability of the result of measurement obtained by the neutron detecting device.

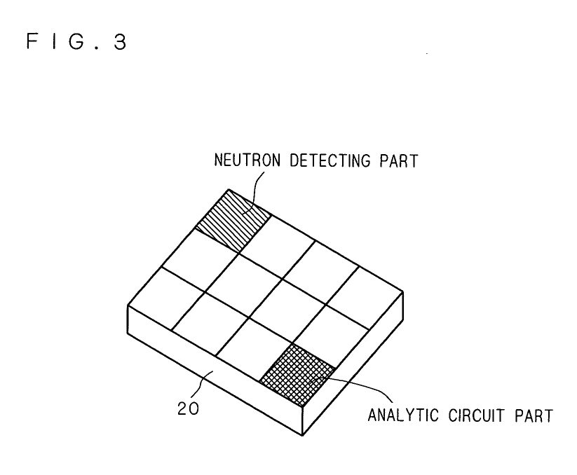

In response, according to the third preferred embodiment of the present invention, the neutron detecting part and the analytic circuit part are arranged on the silicon substrate (semiconductor chip) 1 with a significant distance therebetween. As seen from FIG. 3, for example, the neutron detecting part and the analytic circuit part are diagonally opposite to each other on the same semiconductor chip 20. As described, disturbance in measurement of a neutron radiation field is suppressed to a greater extent as a distance between the neutron detecting part and the α-ray detecting part becomes shorter. In light of this, the α-ray detecting part is arranged in any one of blank areas shown in FIG. 3 which is in a periphery of the neutron detecting part. As a result, the analytic circuit part is placed farther from the neutron detecting part (¹⁰B diffusion layer 10) than the α-ray detecting part (pn junction 13).

Similar to the second preferred embodiment, the neutron detecting part and the α-ray detecting part may be provided in the same element region. In this case, with reference to FIG. 3, the α-ray detecting part is arranged within the same area as the neutron detecting part.

It is thus allowed to suppress entering of an α-ray generated in the neutron detecting part into the analytic circuit part, to control generation of a malfunction (soft error) of the analytic circuit part. Further, the third preferred embodiment can be responsive to measurement of a neutron radiation field having high radiation dose of neutrons. Still further, close proximity of the neutron detecting part and the α-ray detecting part provides improvement in detection efficiency and detection accuracy of an α-ray, whereby high-precision and high-reliability measurement of a neutron radiation field is realized.

While the invention has been shown and described in detail, the foregoing description is in all aspects illustrative and not restrictive. It is therefore understood that numerous modifications and variations can be devised without departing from the scope of the invention.

What is claimed is:

1. A semiconductor device, comprising:
a ¹⁰B diffusion layer containing an isotope ¹⁰B of boron introduced therein;
a pn junction for detecting an α-ray generated in said ¹⁰B diffusion layer; and
an analytic circuit for analyzing electric charge generated in said pn junction, wherein
said ¹⁰B diffusion layer, said pn junction, and said analytic circuit are provided on a single semiconductor chip.

2. The semiconductor device according to claim 1, wherein
a p-type diffusion layer for defining said pn junction is said ¹⁰B diffusion layer.

3. The semiconductor device according to claim 2, wherein
said ¹⁰B diffusion layer is provide in a periphery of an upper surface of said semiconductor chip, and
an n-type diffusion layer is provided under said ¹⁰B diffusion layer, said n-type diffusion layer defining said pn junction together with said ¹⁰B diffusion layer.

4. The semiconductor device according to claim 1, wherein
said analytic circuit is arranged farther from said ¹⁰B diffusion layer than said pn junction.
